(19) United States
(12) Patent Application Publication
(10) Pub. No.: US 2022/0417096 A1
(43) Pub. Date: Dec. 29, 2022

(54) AUTOMATIC IDENTIFICATION OF POLICY MISCONFIGURATION

(71) Applicant: VMware, Inc., Palo Alto, CA (US)

(72) Inventors: Aditi Vutukuri, Atlanta, GA (US); Tejas Sanjeev Panse, San Jose, CA (US); Margaret Petrus, San Jose, CA (US); Arnold Koon-Chee Poon, San Mateo, CA (US); Rajiv Mordani, Fremont, CA (US)

(21) Appl. No.: 17/355,829

(22) Filed: Jun. 23, 2021

(51) Int. Cl. H04L 12/24; H04L 12/26

(52) U.S. Cl. CPC H04L 41/0866; H04L 43/04; H04L 41/0686

(57) ABSTRACT

Some embodiments provide a method for identifying policy misconfiguration in a datacenter. Based on flow data received for a plurality of data compute nodes (DCNs) in the datacenter, the method determines that an anomalous amount of data traffic relating to a particular DCN has been dropped. The method uses (i) the received flow data for the particular DCN and (ii) a set of recent policy configuration changes to determine policy configuration changes that contributed to the anomalous amount of dropped data traffic relating to the particular DCN. The method generates an alert for presentation to a user indicating the anomalous amount of data traffic and the contributing policy configuration changes.

### BACKGROUND

Network administrators are often skeptical about making any changes to network policies (e.g., firewall policies) because of the potential to affect applications operating in a datacenter. Over time, new policies are added but old policies are not removed, causing the overall policy to become very complicated and error prone. With rapidly growing networks, this problem is compounded because new policies are added even more quickly. Given this problem, a mechanism for network administrators to modify policies without concern that existing applications are affected is needed.

### BRIEF SUMMARY

Some embodiments provide a method for automatically identifying potential policy misconfiguration in a datacenter and alerting an administrator of the datacenter of the potential misconfiguration. Some such embodiments leverage a data flow collection system for the datacenter that collects and reports attributes of data flows associated with data compute nodes (e.g., virtual machines (VMs), containers, bare metal computing devices, etc.) executing in the datacenter. Agents on host computers (or operating directly on bare metal computing devices) collect and export data flow information for the data compute nodes (DCNs) to an analysis appliance (e.g., a single server or cluster of servers) that, among other analysis tasks, processes the data flow information to identify when an anomalous amount of traffic relating to a particular DCN has been dropped. Upon detection of such an anomaly, the analysis appliance uses (i) the flow data for the particular DCN and (ii) a stored list of recent policy configuration changes in order to determine which policy configuration changes may have contributed to the anomalous amount of dropped traffic relating to the particular DCN. In some embodiments, the analysis appliance then generates an alert for presentation to a datacenter administrator that indicates the anomalous amount of dropped data traffic and the potentially contributing policy changes.

To determine that an anomalous amount of data traffic relating to a particular DCN has been dropped, some embodiments compare the amount of dropped data traffic relating to the particular DCN over a particular time period (e.g., the current day) with a historical baseline amount of dropped traffic relating to the particular DCN (e.g., the daily amount of dropped traffic over the previous 30 days, 60 days, etc.). In some embodiments, the analysis appliance includes a specific anomaly detector module that performs this comparison on a regular basis (e.g., every 30 minutes, every hour, etc.) for each DCN in the datacenter (or each of a set of DCNs). In addition, for each DCN, some embodiments perform the comparison separately for both incoming and outgoing data traffic.

In some embodiments, the anomaly detector performs multiple such comparisons and weights the different comparisons to determine whether an anomaly has occurred. For instance, some embodiments compute an average amount of total dropped traffic relating to a DCN each day over the baseline time period and then determine whether the amount of dropped traffic for the current day is greater than a particular number of standard deviations (e.g., 3×) above the computed average. If the total amount of traffic sent to or from a DCN remains approximately constant, then this first comparison provides a good indication as to whether an anomalous amount of traffic to or from the DCN is being dropped. However, if the total amount of traffic is much different than usual, this analysis can either miss an anomaly (if the total traffic is small) or provide a false positive (if the total traffic is large).

For a second comparison, some embodiments compute the average ratio of allowed (i.e., not dropped) data traffic to total data traffic relating to a DCN over the baseline time period and then determine whether the ratio for the current day is less than the average ratio. This analysis normalizes for differences in total traffic sent to or from the DCN. However, for very small amounts of traffic, small changes in the amount of traffic dropped can have a large effect on the ratio.

A third comparison used in some embodiments looks for new types of traffic that are dropped. Specifically, some embodiments analyze the dropped data traffic for a DCN over the baseline time period to identify a set of destination port numbers to which the dropped data traffic was directed. When dropped data traffic for the DCN is directed to new port numbers (i.e., port numbers not in the identified set of port numbers), this may be indicative of the effect of a new or modified security policy. Certain ports may be intentionally blocked, but if http (or similarly common) traffic is suddenly blocked, this may be the result of a change in policy.

As mentioned, rather than using any one of these comparisons as a single factor to determine whether an anomalous amount of traffic has been dropped, some embodiments assign a score for each comparison (e.g., based on the amount by which the total dropped traffic is above the average, the amount by which the ratio of allowed to total traffic is below the average, and the number of new destination port numbers in the dropped traffic). The anomaly detector then weights these scores to compute a total score for each DCN and direction (incoming/outgoing). The weights can be preset, adjusted by an administrator, or automatically modified based on administrator feedback in different embodiments. The total score is compared to a threshold score to determine whether an anomaly is present. In some embodiments, this threshold score is adjustable by the network administrator (e.g., by direct modification or by changing a sensitivity meter that modifies the threshold in turn).

When the anomaly detector identifies an anomalous amount of dropped traffic relating to a particular DCN in a particular direction, the analysis appliance of some embodiments attempts to correlate the anomaly with one or more policy configuration changes that may have contributed to the traffic drops. When an anomaly is identified, the appliance has information that includes an identifier for the particular DCN, the specific firewall rules that blocked the traffic, and group identifiers for security groups to which the particular DCN belongs and that are used to specify source and destination criteria for the specific firewall rules that blocked the traffic. In addition, the analysis appliance receives (e.g., from a network manager cluster) and stores a list (e.g., a database) of recent policy configuration changes with timestamps for those changes.

The analysis appliance (e.g., a configuration change tracking module) looks for changes affecting the identified firewall rules and/or security group identifiers in order to identify potential changes that may have contributed to the anomalous amount of dropped data traffic relating to the particular DCN. These changes may include new or deleted firewall rules, modified firewall rules, new security groups, changes to security group membership (involving the particular DCN or other DCNs), and/or changes to security group definitions. The analysis appliance can use the timestamps of these changes along with the timestamps for the dropped traffic to identify which changes most likely contributed to the anomalous dropped traffic.

The analysis appliance also provides an alert that presents this information to the network administrator in some embodiments. In some embodiments, this presentation includes a graph of the amount of incoming or outgoing dropped traffic for the particular DCN over an extended time period (e.g., the baseline time period up through the current day). In addition, the presentation provides an indication as to when the identified policy changes occurred. In some embodiments, this indication is selectable to view a description of the policy changes. The presentation, in some embodiments, may provide additional information (e.g., the other DCNs that either sent or failed to receive the dropped traffic, which new ports were blocked, how many firewall rules contributed to the traffic being dropped, etc.). This presentation allows the network administrator to quickly identify possible problems and determine whether resolution of the problem is needed.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an analysis appliance of some embodiments.

FIG. 2 conceptually illustrates a host computer of some embodiments.

FIG. 3 conceptually illustrates a process of some embodiments for identifying DCNs for which an anomalous amount of data traffic in a particular direction (incoming or outgoing) has been dropped.

FIG. 4 illustrates example statistics used to perform drop analysis for a set of DCNs,

FIG. 5 conceptually illustrates a process of some embodiments for correlating a detected dropped traffic anomaly with contributing policy configuration changes and providing this information to a user.

FIG. 6 illustrates an example user interface (UI) visualization provided by the analysis appliance of some embodiments.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for automatically identifying potential policy misconfiguration in a datacenter and alerting an administrator of the datacenter of the potential misconfiguration. Some such embodiments leverage a data flow collection system for the datacenter that collects and reports attributes of data flows associated with data compute nodes (e.g., virtual machines (VMs), containers, bare metal computing devices, etc.) executing in the datacenter. Agents on host computers (or operating directly on bare metal computing devices) collect and export data flow information for the data compute nodes (DCNs) to an analysis appliance (e.g., a single server or cluster of servers) that, among other analysis tasks, processes the data flow information to identify when an anomalous amount of traffic relating to a particular DCN has been dropped. Upon detection of such an anomaly, the analysis appliance uses (i) the flow data for the particular DCN and (ii) a stored list of recent policy configuration changes in order to determine which policy configuration changes may have contributed to the anomalous amount of dropped traffic relating to the particular DCN. In some embodiments, the analysis appliance then generates an alert for presentation to a datacenter administrator that indicates the anomalous amount of dropped data traffic and the potentially contributing policy changes.

To determine that an anomalous amount of data traffic relating to a particular DCN has been dropped, some embodiments compare the amount of dropped data traffic relating to the particular DCN over a particular time period (e.g., the current day) with a historical baseline amount of dropped traffic relating to the particular DCN (e.g., the daily amount of dropped traffic over the previous 30 days, 60 days, etc.). In some embodiments, the analysis appliance includes a specific anomaly detector module that performs this comparison on a regular basis (e.g., every 30 minutes, every hour, etc.) for each DCN in the datacenter (or each of a set of DCNs). In addition, for each DCN, some embodiments perform the comparison separately for both incoming and outgoing data traffic.

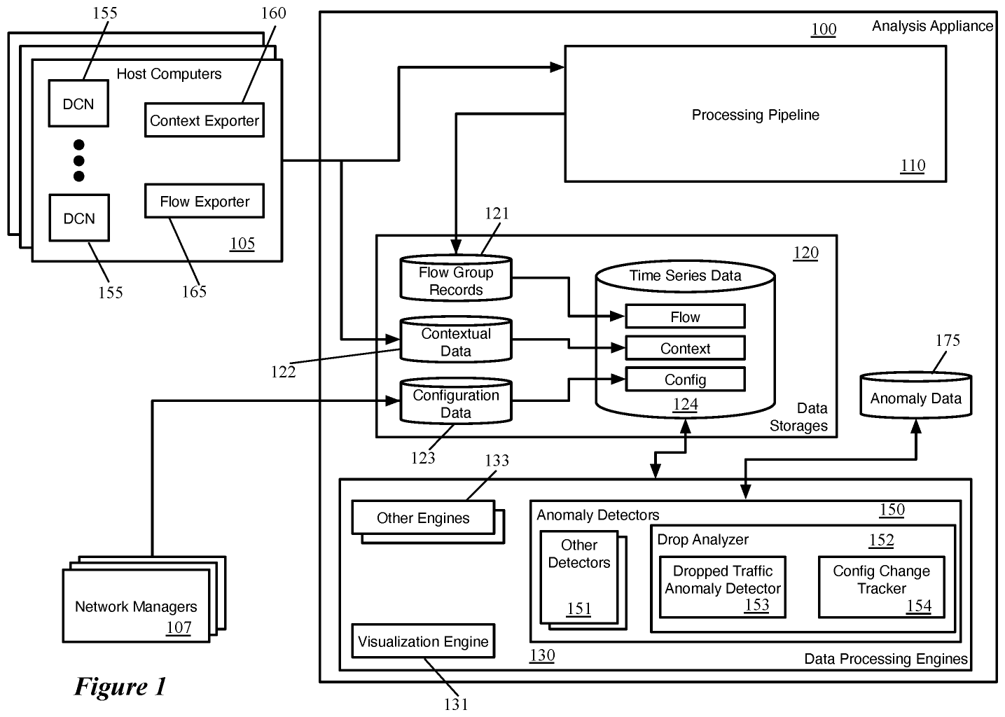

FIG. 1 conceptually illustrates the analysis appliance 100 of some embodiments, as well as network managers 107 and host computers 105. The analysis appliance 100 includes a processing pipeline 110 for flow data (e.g., flow attribute sets received from host computers), a set of data storages 120 for storing received data, and a set of data processing engines 130 including a set of anomaly detectors 150 as well as a visualization engine 131 and other engines 133).

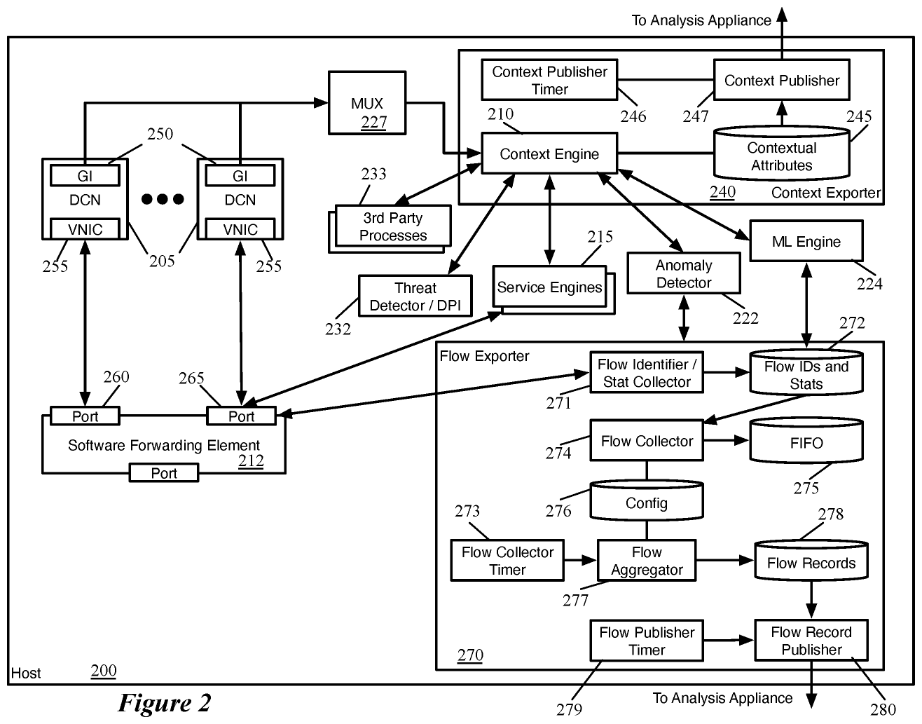

The host computers 105 will be described in greater detail below by reference to FIG. 2. As shown, these host computers execute one or more DCNs 155 (e.g., VMs, containers, etc.) that can run services, applications, etc. These DCNs 155 send and receive data traffic, which are organized as data message flows and are processed by other modules executing on the host computers 105. Each host computer 105 also executes (e.g., within virtualization software) a context exporter 160 and a flow exporter 165, which are associated with the analysis appliance 100. The context exporter 160 collects context data regarding the DCNs 155 and provides this data to the analysis appliance 100. The flow exporter 165 collects information about data flows to and from the DCNs 155 and provides this data to the analysis appliance 100.

The network managers 107 provide configuration data to the analysis appliance 100, including management plane configuration data and policy configuration data. This policy configuration data can include distributed firewall rules enforced by the host computers 105 as well as security group memberships that are used to define these firewall rules. For instance, in some embodiments, each time a firewall rule is added, deleted, or modified, these changes are provided by the network managers 107 to the analysis appliance 100. Similarly, each time the membership of a security group changes, due to the creation, deletion, or modification of a DCN or because the definition of the group has changed (or a group has been wholesale created or deleted), these changes are provided to the analysis appliance 100 along with timestamps specifying when each change was made.

In addition, the analysis appliance 100 communicates control messages (e.g., updates to service rule policies, updated keys, updated group memberships validated by a user, etc.) through the network managers 107. In some embodiments, a user (e.g., an administrator, not shown) can interact with the analysis appliance 100 directly (e.g., to provide commands to the visualization engine 131).

The processing pipeline 110, in some embodiments, processes flow data (e.g., flow attribute sets, also referred to as flow group records) received from the host computers in the system for analysis by other elements of the appliance (e.g., the anomaly detectors 150). When two DCNs 155 within the datacenter communicate with each other and their respective host computers 105, both provide flow attribute sets for the flow to the analysis appliance 100. The processing pipeline 110 deduplicates these flow attribute sets (i.e., into a single flow attribute set). This deduplication process matches these flows (e.g., based on flow keys) and, in some embodiments, generates a new flow attribute set for the data flow that includes all unique attributes from both the source and destination host computer flow attribute sets. The processing pipeline 110 stores these flow attribute sets in the data storages 120 (e.g., the flow group records 121). In some embodiments, in addition to deduplication, the processing pipeline 110 also identifies and groups corresponding flow attribute sets (e.g., for reverse direction flows or otherwise-related flows). These flow attribute sets are also combined and stored in, e.g., the flow group records 121. In some embodiments, the flow data includes flow attribute sets for data flows that are dropped/blocked. When a data flow is dropped or blocked at the source host computer 105 (i.e., the host computer 105 at which the source DCN is located), deduplication is not required because the flow will not appear at the destination.

The processing pipeline 110 of some embodiments also fills in missing information for flow attribute sets, if needed (e.g., DCN identifiers for remote DCNs, etc.) using other flow attribute sets or other information (e.g., by matching DCN identifiers to network addresses already present in the flow attribute sets). Correlation of flow attribute sets can again be performed after this missing information is filled in. Additional description of the processing pipeline 110 is found in U.S. patent application Ser. No. 16/520,220, which is incorporated herein by reference.

The data storages 120 include, in some embodiments, a data storage for each different type of data received (e.g., a correlated flow group record data storage 121, a contextual attribute data storage 122, a configuration data storage 123, and a time series data storage 124). The contextual attribute data storage 122, in some embodiments, stores received contextual attribute data from multiple host computers and uses that data for populating the time series data storage 124 with contextual attribute data (e.g., in a contextual attribute topic). In some embodiments, the contextual attribute data storage 122 is used in correlating contextual attributes with flow group records for display. The time series data storage 124 is used additionally, or alternatively, in other embodiments, for correlating contextual attribute data to flow group record data.

The contextual attribute data storage 122, in some embodiments, receives contextual attribute data sets including any, or all, of: data regarding guest metadata, guest events, and guest DCN metrics. In some embodiments, the guest metadata includes any or all of DCN details (a universally unique identifier [uuid], a bios uuid, and a vmxpath), operating system details (type of OS and version information), and process details (e.g., process ID, creation time, hash, name, command line, security ID [sid], user ID [uid], loaded library or module information, process metrics [e.g., memory usage and CPU usage], process version, parent process ID, etc.). Guest events, in some embodiments, include DCN events (e.g., power on and power off), user login events (e.g., login, logoff, connect, and disconnect events, a session ID, a timestamp, a DCN IP, and a connected client IP), and service process events (e.g., event type [e.g., listen start, listen stop], timestamp, destination DCN IP, destination port number, and process details). Guest DCN metrics, in some embodiments, include memory usage and CPU usage. It should be understood that many additional pieces of information may be provided to a contextual attribute data storage and that the partial list above serves only as an example.

In some embodiments, the set of data storages 120 includes a flow group record data storage 121. In some embodiments, this data storage 121 stores flow attribute sets after aggregation and correlation with configuration data stored in the configuration data storage 123. The flow group record data storage 121, in some embodiments, also stores learned pairings of IP addresses and DCN identifiers. In some embodiments, the learning is based on previously processed flow record groups. The correlated flow group record data storage 121, in some embodiments, provides processed (e.g., aggregated and correlated) flow group records to the time series data storage. These flow group records include information for both allowed and dropped flows.

The configuration data storage 123, in some embodiments, receives configuration data (e.g., management plane configuration and/or policy configuration) from a network manager controller. The management plane configuration data includes information relating to group membership (in terms of DCN), and the policy configuration data sets include information about service rules (e.g., firewall rules), in some embodiments. The service rules, in some embodiments, are expressed in terms of any of IP addresses, ports, protocols, security groups, etc., in any combination. In some embodiments, an initial set of configuration data is sent at startup or reboot of either the network manager computer or the analysis appliance, while subsequent configuration data sets include only changes to the last configuration data set.

A time series data storage 124, in some embodiments, stores flow group records, configuration data, and context data. In some embodiments, the time series data storage 124 is organized by topic with each different type of data stored in a different topic. Additionally, in some embodiments, each topic is organized in a time series fashion by use of an index that is appended to each set of data and is coordinated among all the producers of data for the topic. The time series data storage 124 is organized at multiple levels of temporal granularity, in some embodiments. In some embodiments, the different levels of granularity include some combination of hourly, daily, weekly, and monthly levels. The different levels of temporal granularity are used, in some embodiments, for data collected for a previous 24 hours (e.g., organized on an hourly basis), data for a previous 6 days (e.g., organized on a daily basis), data for a previous 30 days (e.g., organized on a daily or weekly basis), and data received more than 30 days earlier (e.g., organized on a monthly basis). The data organized based on the various levels of temporal granularity are, in some embodiments, periodically (e.g., daily, hourly, etc.) rolled up into the next level of granularity.

The data processing engines 130, as mentioned, include one or more anomaly detectors 150 as well as a visualization engine 131 and a set of other engines 133. The anomaly detectors 150 analyze the time series data 124 to detect various types of anomalies in the datacenter network. For instance, anomaly detectors 150 might look for various types of attacks on the network (e.g., port scans) or other types of anomalies. The drop analyzer 152 of some embodiments finds anomalous amounts of dropped traffic relating to specific DCNs and identifies possible policy misconfigurations that could have caused these anomalous traffic patterns. In some embodiments, the drop analyzer 152 includes a dropped traffic anomaly detector 153 that analyzes the time series flow data (e.g., on a regular basis such as every half hour) to identify the anomalous traffic patterns, as described in detail below. The configuration change tracker module 154 queries the policy configuration change data stored in the time series data 124 to identify the configuration changes most likely to have resulted in the anomalous traffic patterns. The drop analyzer 152 (as well as the other detectors 151, in some embodiments) store anomaly event data in the data store 175. This anomaly event data store 175 may be part of the time series data store 124 or can exist as its own separate data store (e.g., a separate relational database).

The anomalies stored in the data store 175 can also be reported to the network manager 107 or to a user interface (e.g., via the visualization engine 131). The visualization engine 131, in some embodiments, generates a graphical user interface that can be used to provide information about DCNs, including flows, contextual attributes, anomalous events relating to the DCN, etc. Additional information about the data storages 120 and the processing engines 130 (and the analysis appliance 100 more generally) can be found in U.S. patent application Ser. No. 16/520,220, which is incorporated by reference above.

FIG. 2 conceptually illustrates a host computer 200 (e.g., one of the host computers 105) of some embodiments in more detail, specifically focusing on the context exporter 240 and flow exporter 270 that collect, aggregate, and publish aggregated data to the analysis appliance. As shown, the host computer 200 also executes several data compute nodes (DCNs) 205, a set of service engines 215, a threat detector/deep packet inspection (DPI) module 232, a set of third-party processes 233, a MUX (multiplexer) 227, an anomaly detector 222, a machine learning (ML) engine 224, and a software forwarding element 212.

Guest introspection agents 250 execute on the DCNs 205 and extract context data from the DCNs 205. For example, a guest introspection agent 250, in some embodiments, detects that a new data flow has been initiated (e.g., by sending a SYN packet in a data flow using TCP) and collects introspection data (e.g., a set of attributes of the data flow and DCN). The introspection data, in some embodiments, includes any, or all, of data regarding (i) guest metadata, (ii) guest events, and (iii) guest DCN metrics. In some embodiments, the guest metadata includes any, or all, of data regarding DCN 205 (a universally unique identifier [uuid], a bios uuid, and a vmxpath), operating system data (type of OS and version information), and process data (e.g., process ID, creation time, hash, name, command line, security ID [sid], user ID [uid], loaded library or module information, process metrics [e.g., memory usage and CPU usage], process version, parent process ID, etc.). Guest events, in some embodiments, include DCN events (e.g., power on and power off), user login events (e.g., login, logoff, connect, and disconnect events, a session ID, a timestamp, a DCN IP, and a connected client IP), and service process events (e.g., event type [e.g., listen start, listen stop], timestamp, destination DCN IP, destination port number, and process details). Guest DCN metrics, in some embodiments, include memory usage and CPU usage. It should be understood that much of the context data, in some embodiments, is not included in L2-L7 headers of a flow and that many additional pieces of information may be collected by guest introspection agent 250. The partial list above serves only as an example of the types of information that can be gathered by guest introspection agent 250.

In some embodiments, the guest introspection agents 250 send the collected context information to the context exporter 240 (specifically to the context engine 210) through a multiplexer 227. The context exporter 240 includes the context engine 210, a contextual attribute storage 245, a context publisher timer 246, and a context publisher 247. The context exporter 240 processes context data (e.g., contextual attribute data sets) at the host computer 200 and publishes the context data to the analysis appliance. The context engine 210 also provides the received context information to other elements operating in the host computer 200 and correlates this context data with context data received from other sources.

In some embodiments, the other sources include the set of service engines 215, the threat detector/DPI module 232, third-party software (processes) 233, the anomaly detector 222, and the ML engine 224. The context engine 210, in some embodiments, correlates the context data from the multiple sources for providing the correlated context data (e.g., sets of correlated contextual attributes) to the context publisher 247 (e.g., through context attribute storage 245).

As shown, each DCN 205 also includes a virtual network interface controller (VNIC) 255 in some embodiments. Each VNIC is responsible for exchanging messages between its respective DCN and the SFE 212 (which may be, e.g., a virtual switch or a set of virtual switches). Each VNIC 255 connects to a particular port 260-265 of the SFE 212. The SFE 212 also connects to a physical network interface controller (PNIC) (not shown) of the host. In some embodiments, the VNICs are software abstractions of one or more physical NICs (PNICs) of the host created by the virtualization software of the host (within which the software forwarding element 212 executes).

In some embodiments, the SFE 212 maintains a single port 260-265 for each VNIC of each DCN. The SFE 212 connects to the host PNIC (through a NIC driver [not shown]) to send outgoing messages and to receive incoming messages. In some embodiments, the SFE 212 is defined to include one or more ports that connect to the PNIC driver to send and receive messages to and from the PNIC. The SFE 212 performs message-processing operations to forward messages that it receives on one of its ports to another one of its ports. For example, in some embodiments, the SFE 212 tries to use data in the message (e.g., data in the message header) to match a message to flow-based rules, and upon finding a match, to perform the action specified by the matching rule (e.g., to hand the message to one of its ports, which direct the message to be supplied to a destination DCN or to the PNIC).

In some embodiments, the SFE 212 is a software switch (e.g., a virtual switch), while in other embodiments it is a software router or a combined software switch/router, and may represent multiple SFEs (e.g., a combination of virtual switches and virtual routers). The SFE 212, in some embodiments, implements one or more logical forwarding elements (e.g., logical switches or logical routers) with SFEs 212 executing on other hosts in a multi-host environment. A logical forwarding element, in some embodiments, can span multiple hosts to connect DCNs that execute on different hosts but belong to one logical network. Different logical forwarding elements can be defined to specify different logical networks for different users, and each logical forwarding element can be defined by multiple software forwarding elements on multiple hosts. Each logical forwarding element isolates the traffic of the DCNs of one logical network from the DCNs of another logical network that is serviced by another logical forwarding element. A logical forwarding element can connect DCNs executing on the same host and/or different hosts, both within a datacenter and across datacenters. In some embodiments, the SFE 212 extracts from a data message a logical network identifier (e.g., a VNI) and a MAC address. The SFE 212, in such embodiments, / uses the extracted VNI to identify a logical port group or logical switch, and then uses the MAC address to identify a port within the port group or logical switch.

The ports of the SFE 212, in some embodiments, include one or more function calls to one or more modules that implement special input/output (I/O) operations on incoming and outgoing messages that are received at the ports 260-265. Examples of I/O operations that are implemented by the ports 260-265 include ARP broadcast suppression operations and DHCP broadcast suppression operations, as described in U.S. Pat. No. 9,548,965. Other I/O operations (such as firewall operations, load-balancing operations, network address translation operations, etc.) can be so implemented in some embodiments of the invention. By implementing a stack of such function calls, the ports 260-265 can implement a chain of I/O operations on incoming and/or outgoing messages in some embodiments. Also, in some embodiments, other modules in the data path (such as the VNICs 255 and the ports 260-265, etc.) implement the I/O function call operations instead of, or in conjunction with, the ports 260-265. In some embodiments, one or more of the function calls made by the SFE ports 260-265 can be to service engines 215, which query the context engine 210 for context information that the service engines 215 use (e.g., to generate context headers that include context used in providing a service and to identify service rules applied to provide the service). In some embodiments, the generated context headers are then provided through the port 260-265 of SFE 212 to flow exporter 270 (e.g., flow identifier and statistics collector 271).

The service engines 215 can include a distributed firewall engine of some embodiments that implements distributed firewall rules configured for the datacenter network. These distributed firewall rules are, in some embodiments, defined in terms of rule identifiers, and specify whether to drop or allow traffic from one group of DCNs to another group of DCNs. The firewall rules can be specified in terms of source and destination network addresses (e.g., IP and/or MAC addresses) and/or security groups (which are converted to network addresses). For instance, a firewall rule might be defined at the network manager level as allowing any traffic from a set of web server VMs running the Linux operating system (a first security group) to a set of database server VMs running the Windows operating system (a second security group). This firewall rule is then translated into a set of more specific rules based on the membership of the DCNs in the first and second security groups using the IP and/or MAC addresses of these DCNs.

The flow exporter 270 monitors flows, collects flow data and statistics, aggregates flow data into flow group records, and publishes flow attribute sets (also referred to as flow group records) for consumption by the analysis appliance. In some embodiments, the flow exporter 270 generally aggregates statistics for individual flows identified during multiple time periods, and for each time period identifies multiple groups of flows with each group including one or more individual flows. For each identified flow group, the flow exporter 270 identifies a set of attributes by aggregating one or more subsets of attributes of one or more individual flows in the group as described below in greater detail. In some embodiments, the subset of attributes of each individual flow in each group is the aggregated statistics of the individual flow. After the multiple time periods, flow exporter 270 provides the set of attributes for each group identified in the multiple time periods to the analysis appliance for further analysis of the identified flows.

As shown, the flow exporter 270 includes a flow identifier/statistics collector 271, a flow identifier and statistics storage 272, a flow collector timer 273, a flow collector 274, a first-in first-out (FIFO) storage 275, a configuration data storage 276, a flow aggregator 277, a flow group record storage 278, a flow publisher timer 279, and a flow group record publisher 280. These modules collectively collect and process flow data to produce and publish flow attribute sets.

The flow exporter 270 receives flow information, including flow identifiers and statistics, at the flow identifier/statistics collector 271. In some embodiments, the received flow information is derived from individual data messages that make up the flow and includes context data used in making service decisions at service engines 215. In some embodiments, the flow information also specifies which firewall rules are applied to each flow (e.g., using firewall rule identifiers). The flow exporter 270 stores the received information associated with particular flows in the flow identifier and statistics storage 272. The statistics, in some embodiments, are summarized (accumulated) over the life of the particular flow (e.g., bytes exchanged, number of packets, start time, and duration of the flow).

The flow collector 274, in some embodiments, monitors the flows to determine which flows have terminated (e.g., timeouts, FIN packets, RST packets, etc.) and collects the flow identifiers and statistics and pushes the collected data to FIFO storage 275. In some embodiments, the flow collector 274 collects additional configuration data from configuration data storage 276 and includes this additional configuration data with the data collected from flow identifier and statistics storage 272 before sending the data to FIFO storage 275.

Additionally, the flow collector 274, in some embodiments, collects data for long-lived active flows (e.g., flows lasting longer than half a publishing period) from the flow identifier and statistics storage 272 before the end of a publishing period provided by flow publisher timer 279. In some embodiments, the data collected for a long-lived active flow is different from the data collected for terminated flows. For example, active flows are reported using a start time but without a duration in some embodiments. Some embodiments also include flows that are initiated but dropped/blocked based on firewall rules.

Only flows meeting certain criteria are collected by the flow collector 274 in some embodiments. For example, only information for flows using a pre-specified set of transport layer protocols (e.g., TCP, UDP, ESP, GRE, SCTP) are collected, while others are dropped or ignored. In some embodiments, additional types of traffic, such as broadcast and multicast, safety check (e.g., having ruleID=0 or 0 rx and tx byte/packet counts), L2 flows, flows which are not classified as one of (i) inactive, (ii) drop, or (iii) reject, are dropped (i.e., not collected or not placed into FIFO storage 275).

In some embodiments, the FIFO storage 275 is a circular or ring buffer such that only a certain number of sets of flow identifiers and flow statistics can be stored before old sets are overwritten. In order to collect all the data placed into FIFO storage 275, or at least to not miss too much (e.g., miss less than 5% of the data flows), the flow aggregator 277 pulls data stored in FIFO storage 275 based on a flow collection timer 273 and aggregates the pulled data into aggregated flow group records. Some embodiments pull data from the FIFO storage 275 based on a configurable periodicity (e.g., every 10 seconds), while other embodiments, alternatively or in addition to the periodic collection, dynamically determine when to collect data from FIFO storage 275 based on a detected number of data flows (e.g., terminated data flows, a total number of active data flows, etc.) and the size of FIFO storage 275. Each set of flow data pulled from FIFO storage 275 for a particular flow, in some embodiments, represents a unidirectional flow from a first endpoint (e.g., machine or DCN) to a second endpoint. If the first and second endpoints both execute on the same host computer 200, in some embodiments, a same unidirectional flow is captured at different ports 260-265 of the software forwarding element 212. To avoid double counting a same data message provided to the flow identifier 271 from the two ports 260-265, the flow identifier 271 uses a sequence number or other unique identifier to determine if the data message has been accounted for in the statistics collected for the flow. Even if duplicate data messages for a single unidirectional flow have been accounted for, the flow aggregator 277 additionally combines sets of flow data received for the separate unidirectional flows into a single set of flow data in some embodiments. This deduplication (deduping) of flow data occurs before further aggregation in some embodiments and, in other embodiments, occurs after an aggregation operation.

The flow aggregator 277, in some embodiments, receives a set of keys from the analysis appliance through the network manager computer that specify how the flow data sets are aggregated. After aggregating the flows, the flow aggregator 277 performs a deduplication process to combine aggregated flow group records for two unidirectional flows between two DCNs 205 executing on host machine 200 into a single aggregated flow group record and stores the aggregated records in flow group record storage 278. From flow group record storage 278, flow group record publisher 280 publishes the aggregated flow group records to an analysis appliance according to a configurable timing provided by flow publisher timer 279. After publishing the aggregated flow group records (and, in some embodiments, receiving confirmation that the records were received), the records stored for the previous publishing time period are deleted and a new set of aggregated flow group records are generated.

In some embodiments, one of the flow aggregator 277 and the context engine 210 performs another correlation operation to associate the sets of correlated contextual attributes stored in contextual attribute storage 245 with the aggregated flow group records stored in the flow group record storage 278. In some embodiments, the correlation includes generating new flow attribute sets with additional attribute data included in existing attribute fields or appended in new attribute fields. In other embodiments, the sets of correlated contextual attributes and aggregated flow group records are tagged to identify related sets of aggregated flow group records and contextual attribute data. In some embodiments, the generated new flow group records are published from one of the publishers (e.g., flow group record publisher 280 or context publisher 247). In other embodiments, flow group record publisher 280 publishes the tagged aggregated flow group records and the context publisher 247 publishes the tagged sets of correlated contextual attributes.

The anomaly detection engine 222, in some embodiments, receives flow data (from any of flow identifier and statistics storage 272, FIFO storage 275, or flow group record storage 278) and context data from context engine 210 and detects, based on the received data, anomalous behavior associated with the flows. For example, based on context data identifying the application or process associated with a flow, anomaly detection engine 222 determines that the source port is not the expected source port and is flagged as anomalous. The detection, in some embodiments, includes stateful detection, stateless detection, or a combination of both. Stateless detection does not rely on previously collected data at the host, while stateful detection, in some embodiments, maintains state data related to flows and uses the state data to detect anomalous behavior. For example, a value for a mean round trip time (RTT) or other attribute of a flow and a standard deviation for that attribute may be maintained by anomaly detection engine 222 and compared to values received in a current set of flow data to determine that the value deviates from the mean value by a certain number of standard deviations that indicates an anomaly. In some embodiments, anomaly detection engine 222 appends a field to the set of context data that is one of a flag bit that indicates that an anomaly was detected or an anomaly identifier field that indicates the type of anomaly detected (e.g., a change in the status of a flow from allowed to blocked [or vice versa], a sloppy or incomplete TCP header, an application/port mismatch, or an insecure version of an application). In some embodiments, the additional context data is provided to context engine 210 separately to be correlated with the other context data received at context engine 210. As will be understood from the discussion above, the anomaly detection process may use contextual attributes not in L2-L4 headers such as data included in L7 headers and additional context values not found in headers.

In some embodiments, the anomaly detection engine 222 takes an action or generates a suggestion based on detecting the anomaly. For example, anomaly detection engine 222 can block an anomalous flow pending user review or suggest that a new firewall rule be added to a firewall configuration. In some embodiments, the anomaly detection engines 222 on each host computer 200 can report these anomalies (e.g., via the context publisher 247) to the analysis appliance for further analysis by the anomaly processing engine.

The machine learning engine 224, in some embodiments, receives flow data (from any of the flow identifier and statistics storage 272, the FIFO storage 275, and the flow group record storage 278) and context data from the context engine 210 and performs analysis on the received data. The received data (e.g., flow group records), in some embodiments, includes attributes normally recorded in a 5-tuple as well as additional L7 attributes and other contextual attributes such as user sid, process hash, URLs, appId, etc., that allow for better recommendations to be made (e.g., finer-grained firewall rules). In some embodiments, the analysis identifies possible groupings of DCNs 205 executing on the host computer 200. In some embodiments, the analysis is part of a distributed machine learning process, and the results are provided to the context engine 210 as an additional contextual attribute.

As noted above, the analysis appliance of some embodiments uses the flow data received from the host and correlated by the processing pipeline to detect when an anomalous amount of traffic relating to a particular DCN has been dropped. Some embodiments compare the amount of dropped traffic relating to the particular DCN over a particular time period (e.g., the current day) with a historical baseline amount of dropped traffic relating to the particular DCN (e.g., the daily amount of dropped traffic over the previous 30 days, 60 days, etc.). In some embodiments, the drop analyzer 152 shown in FIG. 1 (or a similar module) performs this comparison on a regular basis (e.g., every 30 minutes, every hour, etc.) for each DCN in the datacenter (or each DCN of a set of DCNs). In addition, for each DCN, some embodiments perform the comparison separately for both incoming and outgoing data traffic. In some embodiments, the anomaly detector performs multiple such comparisons and weights the different comparisons to determine whether an anomaly has occurred.

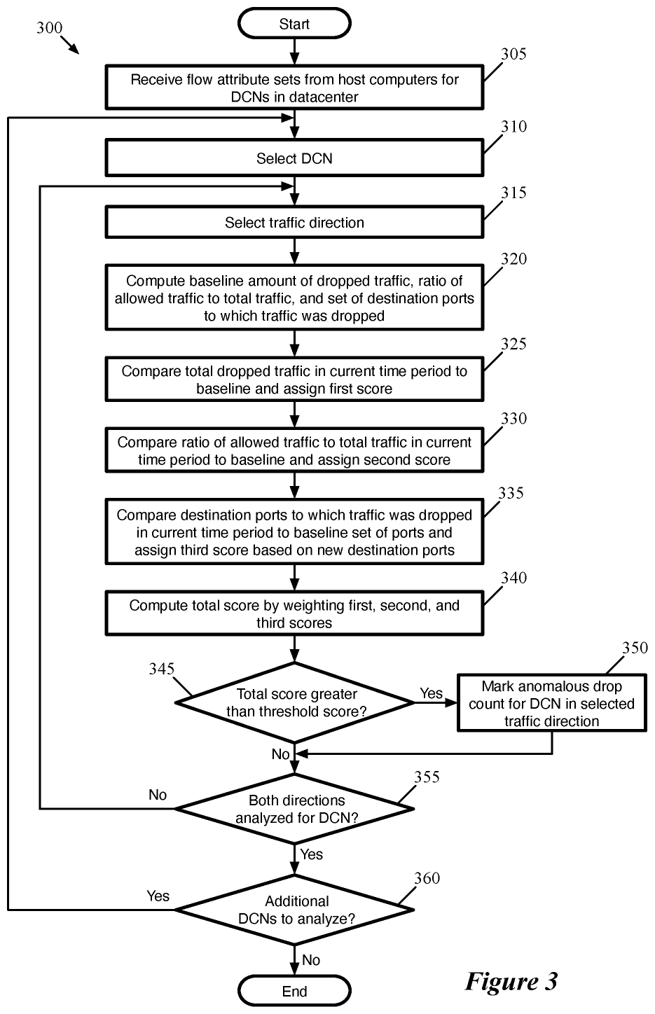

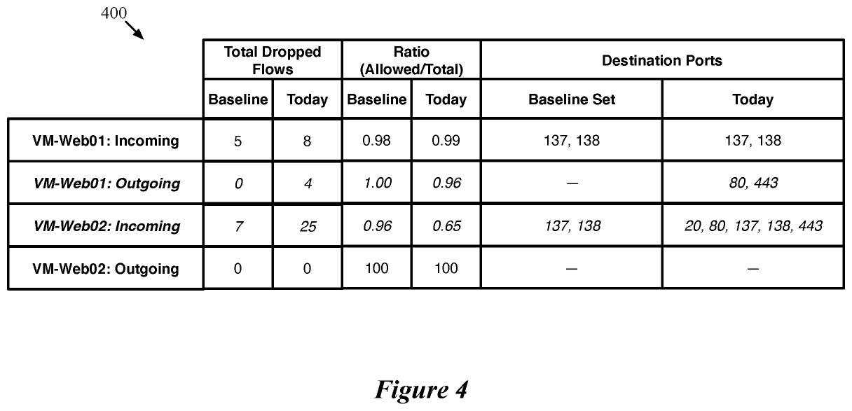

FIG. 3 conceptually illustrates a process 300 of some embodiments for identifying DCNs for which an anomalous amount of data traffic in a particular direction (incoming or outgoing) has been dropped. The process 300 is performed, in some embodiments, by an analysis appliance such as that shown in FIG. 1 (specifically by a drop anomaly detector that is part of such an analysis appliance). In some embodiments, the analysis appliance performs this process (or a similar process) on a regular basis (e.g., every half hour, every hour, etc.). This process 300 will be described, in part, by reference to FIG. 4, which illustrates example statistics used to perform drop analysis for a set of DCNs.

As shown, the process 300 begins by receiving (at 305) flow attribute sets from host computers for DCNs in the datacenter. As described above, the flow exporters on each of the host computers (or a subset of host computers that execute DCNs relevant to the analysis appliance) provide the flow attribute sets to the analysis appliance, which correlates the flow attribute sets and provides them to the anomaly detector in a batch. These flow attribute sets, as described above, indicate the source and destination for each flow, as well as (i) whether the flow is allowed or dropped and (ii) any firewall rules applied to the flows that result in these allow/drop decisions.

The process 300 then selects (at 310) a DCN and (at 315) a traffic direction (i.e., incoming or outgoing traffic for the selected DCN). It should be understood that the process 300 is a conceptual process and that the analysis appliance of some embodiments performs drop analysis for many DCNs and corresponding traffic directions in parallel, rather than serially as shown. In some embodiments, an administrator can configure certain exceptions to the drop analysis process so that traffic to and from certain DCNs (or entire groups of DCNs) are not analyzed (and thus will not generate alerts). For instance, if an administrator is expecting a lot of changes and therefore erratic behavior from a staging environment, the administrator can configure exceptions for specific DCNs or groups (e.g., security groups) of the DCNs in that staging environment so that drop analysis is not performed for those DCNs.

For the current DCN and traffic direction, the process 300 performs several comparisons to determine whether an anomalous amount of traffic has been dropped. In some embodiments, current values for various statistics relating to dropped traffic are compared to baseline values. As shown, the process 300 computes (at 320) baselines for (i) an amount of dropped traffic, (ii) a ratio of allowed traffic to total traffic, and (iii) a set of destination ports to which traffic was dropped. In some embodiments, these baselines are based on the flow data over an extended previous time period. For instance, some embodiments use flow data from the previous 30 days (or a similar time period) to compute the baselines.

The baseline amount of dropped traffic, in some embodiments, is the average daily amount of dropped traffic sent to or from the particular DCN over the baseline time period. The baseline ratio of allowed traffic to total traffic can be either an average of daily ratios over the baseline time period (which is not weighted by the total amount of traffic each day) or the overall ratio of allowed traffic to total traffic during the time period (in which case days with more traffic would have more weight). The baseline set of destination ports for dropped traffic is, in some embodiments, an accumulation of all destination port numbers for relevant dropped traffic during the baseline time period. In addition, some embodiments keep track of the destination port numbers for traffic that was allowed during the baseline time period.

It should be noted that, while the process 300 shows these baseline amounts as being computed for each DCN and traffic direction each time that DCN/direction combination is analyzed, some embodiments precompute the baselines for each DCN/direction combination at the beginning of each day and then use these baseline statistics each time the drop anomaly analysis is performed that day.

The process 300 then compares (at 325) the total dropped traffic (in the selected direction to or from the selected DCN) during the current time period (e.g., the current day) to the baseline amount of total dropped traffic and assigns a first score for the DCN/direction combination based on this comparison. In some embodiments, this first score is 0 unless the total amount of dropped traffic in the current time period exceeds the baseline by a particular amount. That is, if the current amount of dropped traffic is less than the baseline or within, e.g., 3 standard deviations of the baseline, then the process assigns a value of 0 to the first score. However, if the current amount of dropped traffic exceeds the baseline by this particular amount, then a non-zero value is assigned for the first score. Some embodiments divide the amount by which the current time period amount exceeds the baseline by the standard deviation and multiply this value by a normalization constant (e.g., 10) to arrive at the first score.

If the total amount of traffic sent to or from a DCN remains approximately constant during the current time period as compared to the baseline time period, then this first comparison of total dropped traffic provides a good indication as to whether an anomalous amount of traffic to or from the DCN is being dropped. However, if the total amount of traffic is much different than usual, this analysis can either miss an anomaly or provide a false positive. If the total traffic during the time period is very small compared to usual, then the total dropped traffic may not exceed the baseline even if a higher percentage of traffic is dropped. Correspondingly, if there is a large amount of total traffic for some reason, then the usual percentage of dropped traffic may appear as anomalous.

As such, the process 300 also compares (at 330) the ratio of allowed traffic to total traffic (in the selected direction to or from the selected DCN) during the current time period to the baseline ratio of allowed traffic to total traffic and assigns a second score for the DCN/direction combination based on this comparison. Again, some embodiments assign a value of 0 for the second score unless the ratio for the current time period is less than the ratio for the baseline time period by a particular amount. In some embodiments, the second score is calculated as a normalizing factor (e.g., the total flows during the current time period divided by the average number of total flows during the baseline time period, so that days with larger amounts of flows will be weighted more heavily) multiplied by a measurement of the difference in ratio. Some embodiments compute this measurement of the difference in ratio by subtracting the current time period's ratio from the baseline ratio and dividing this difference by the baseline ratio (and then, e.g., multiplying by 100). This analysis normalizes for differences in total traffic sent to or from the currently selected DCN, providing a complement to the first comparison. However, for very small amounts of traffic, small changes in the amount of traffic dropped can have a large effect on the ratio, so an additional normalizing factor is used based on the total traffic.

Lastly, the process 300 compares (at 335) the destination ports of flows that were dropped in the current time period to the baseline set of destination ports and assigns a third score based on these new destination ports. Different embodiments compute this score differently. For instance, some embodiments assign a binary score of either 0 (if there are no new destination ports) or 100 (if there is at least one new destination port). Other embodiments assign the third score based on the number of new destination ports to which traffic was dropped during the current time period (as having more blocked destination ports is more likely to be indicative of a misconfigured policy). Some such embodiments compare the new blocked port numbers to the port numbers for which traffic was allowed during the baseline period (as opposed to port numbers for which no traffic was sent during the baseline period), as these are clearly indicative of a state change for that port number. When dropped data traffic for the DCN is directed to new port numbers (i.e., port numbers not in the identified set of port numbers), this may be indicative of the effect of a new or modified security policy. Certain ports may be intentionally blocked, but if http (or similarly common) traffic is suddenly blocked, this may be the result of a change in policy.

FIG. 4, as mentioned, illustrates example statistics 400 used to perform drop analysis for a set of DCNs. These statistics include data for two DCNs (VM-Web01, VM-Web02) in both incoming and outgoing directions. The statistics include the total number of dropped flows (both baseline average and the current day's data), the percentage of total flows that are allowed, and the destination ports of dropped data flows. In this example, anomalous data is shown in italics. For incoming traffic for the first DCN (VM-Web01), the baseline number of dropped flows is 5 while the total for the current day is 8; however, this amount does not exceed the baseline by a large enough amount to generate a first score. In fact, even though the amount of dropped flows has gone up, the ratio of allowed flows to total flows has increased and only flows to the same port numbers (137, 138, both associated with NetBIOS) have been dropped. As such, no anomaly is identified for incoming traffic to VM-Web01.

Outgoing traffic for this DCN, on the other hand, has an increase from 0 dropped flows to 4, which generates a first anomaly score. Similarly, the ratio of allowed flows to total flows has dropped, generating a second anomaly score. Finally, because no flows were dropped during the baseline period, all dropped traffic includes new destination ports. Here, flows sent to port numbers 80 and 443 (associated with HTTP and HTTPS traffic) were blocked, which is also indicative of anomalous dropped traffic.

For the second DCN (VM-Web02), the dropped incoming flows increases substantially from a baseline average of 7 to 25 for the current day, so this is treated as anomalous. Correspondingly, a much smaller percentage of the total flows sent to the second DCN are allowed (65% compared to a baseline of 96%), and dropped flows are directed to new destination port numbers (20, 80, 443). Accordingly, an anomaly is detected for incoming traffic to VM-Web02. Outgoing traffic for this DCN does not include any dropped flows for the current day (or the baseline), and thus no anomaly is detected.

With the individual scores computed, the process 300 computes (at 340) a total score by weighting the first, second, and third scores. That is, the total score is computed as a combination of a first weighting value multiplied by the first score, a second weighting value multiplied by the second score, and a third weighting value multiplied by the third score. In some embodiments, these weights are preset and are not directly modifiable by a network administrator. In other embodiments, however, the administrator has the ability to directly modify the weights or provide feedback on whether detected anomalies should be treated as such. In the latter case, the analysis appliance may adjust the weights based on this feedback.

Returning to the FIG. 3, the process 300 determines (at 345) whether the total weighted score is greater than a threshold score for determining whether an anomaly is present. This threshold score is adjustable by the network administrator in different embodiments. For instance, the administrator can either modify the threshold score directly if provided insight into the weightings and score values or modify a sensitivity meter in other embodiments. The sensitivity meter of some embodiments allows a user to move the threshold up or down to adjust the sensitivity of the anomaly detector without being directly aware of the scores involved.

If the total score for the current DCN/direction combination is greater than the threshold, then the process 300 marks (at 350) the anomalous drop count for the DCN in the selected direction. As described below, this anomaly is then analyzed further to identify potential policy changes that contributed to the dropped traffic.

Next, the process 300 determines (at 355) whether traffic in both directions (incoming and outgoing) have been analyzed for the selected DCN. If one of the directions remains, the process returns to 315 and performs the analysis for the remaining traffic direction. If both directions have been analyzed, the process 300 determines (at 360) whether additional DCNs remain for analysis and returns to 310 to select the next DCN unless all DCNs have been analyzed. Once both directions have been analyzed for all DNCs, the process ends.

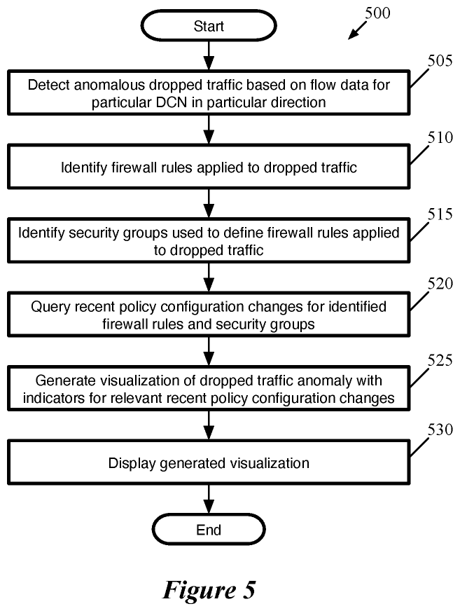

When the anomaly detector identifies an anomalous amount of dropped traffic relating to a particular DCN in a particular direction, the analysis appliance of some embodiments attempts to correlate the anomaly with one or more policy configuration changes that may have contributed to the traffic drops. FIG. 5 conceptually illustrates a process 500 of some embodiments for correlating a detected dropped traffic anomaly with contributing policy configuration changes and providing this information to a user. The process 500 is performed by the analysis appliance of some embodiments, at least in part by the modules of a drop analyzer such as that shown in FIG. 1.

As shown, the process 500 begins by detecting (at 505) anomalous dropped traffic for a particular DCN in a particular direction based on received flow data. This detection operation is performed according to the process 300 shown in FIG. 3 and described in detail above in some embodiments, and involves comparison of multiple different statistics to baseline values. Each anomaly is specified for a particular DCN and a particular traffic direction.

The process 500 then identifies (at 510) firewall rules that are applied to the dropped traffic relating to the particular DCN in the particular direction. As noted above, in some embodiments, each flow attribute set exported from a host computer to the analysis appliance specifies identifiers for any firewall rules applied to the corresponding flow. In addition, if multiple firewall rules are applied to a flow, some embodiments specify which firewall rule resulted in the flow being dropped. Using this data, the analysis appliance can identify which firewall rules caused the relevant data flows to be dropped.

In addition, the process 500 identifies (at 515) security groups used to define the firewall rules that are applied to dropped traffic. In some embodiments, firewall rules are defined by specifying source and destination addresses (e.g., IP and/or MAC addresses) as well as an action (allow, drop, etc.) to take for data messages that match those source and destination addresses. Some embodiments use security groups to specify groups of source or destination addresses. Membership in a security group is defined by a DCN matching a set of characteristics (e.g., type of DCN, operating system, DCN name, or other characteristics), and the network management system for the datacenter determines which DCNs match these characteristics. As such, because the analysis appliance has the set of firewall rules that caused relevant traffic to be dropped, the analysis appliance can determine the security groups used to define these firewall rules (as well as the security group(s) to which the particular DCN belongs).

Next, the process 500 queries (at 520) recent policy configuration changes for the identified firewall rules and security groups. As described above, the time series database of the analysis appliance of some embodiments stores the list of policy configuration changes received from the network managers along with timestamps for each change. These policy configuration changes include addition, deletion, or modification of firewall rules. In addition, each time the membership of a security group changes, due to the creation, deletion, or modification of a DCN or because the definition of the group has changed (or a group has been wholesale created or deleted), these changes are also provided to and stored by the analysis appliance. As such, the drop analyzer queries this time series database using the identified firewall rule identifiers and security group identifiers to determine recent changes to any of these firewall rules or security groups. The query may search for any changes within the past 24 hours, the current day up to the present time, or a shorter window (e.g., 2 hours) in different embodiments.

Using the accumulated data, the process 500 generates (at 525) a visualization of the anomalous dropped traffic that includes indicators for any potentially relevant recent policy configuration changes (i.e., policy configuration changes returned by the query). The process 500 also displays (at 530) this visualization. In some embodiments, the analysis appliance also provides an alert to the network administrator regarding the anomaly so that if policy has been misconfigured it can be corrected quickly.

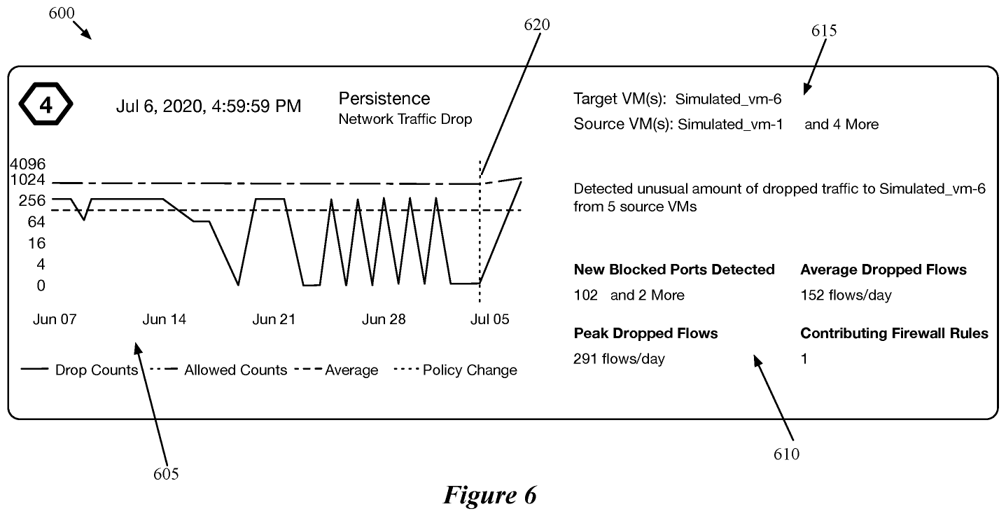

FIG. 6 illustrates an example user interface (UI) visualization 600 provided by the analysis appliance of some embodiments. As shown, the UI visualization 600 includes a dropped traffic graph 605, a statistics section 610, and an anomaly description 615. The dropped traffic graph shows the number of dropped data flows over the past 30 days, the average amount of dropped traffic during that time period, and the number of allowed flows over the time period. In this example, the graph 605 uses a logarithmic scale in order to show both small and large amounts of traffic on the same scale. The graph 605 also includes a vertical line 620 indicating when one or more potentially relevant policy changes were implemented. In some embodiments, this indicator line 620 is selectable (e.g., via a cursor click, cursor hover, or other operation) to cause the UI to provide additional information about the policy changes. The UI, in some such embodiments, specifies the firewall rule and/or security group that was changed, as well as a succinct description of the changes (e.g., addition, deletion, membership change, etc.). This enables the administrator to quickly determine whether to edit these policies if the traffic should not be dropped.

The anomaly description 615 indicates the relevant VM and traffic direction (here, the target VM “Simulated_vm-6” indicates that the dropped traffic is incoming to this VM) as well as a set of source VMs (or destination VMs for outgoing traffic). The anomaly description 615 provides an additional description that an unusual amount of dropped traffic to this VM was detected. The statistics section 610 provides statistics on the average number of dropped flows during the baseline, the peak number of dropped flows, the number of new blocked port numbers (here, this includes port 102 as well as 2 more, which the user can select to view), and the number of firewall rules contributing to this anomaly. Some embodiments also provide a selectable item or set of selectable items that allow the user to dismiss the anomaly, jump to a UI page allowing for editing of the contributing policies, or take other actions.

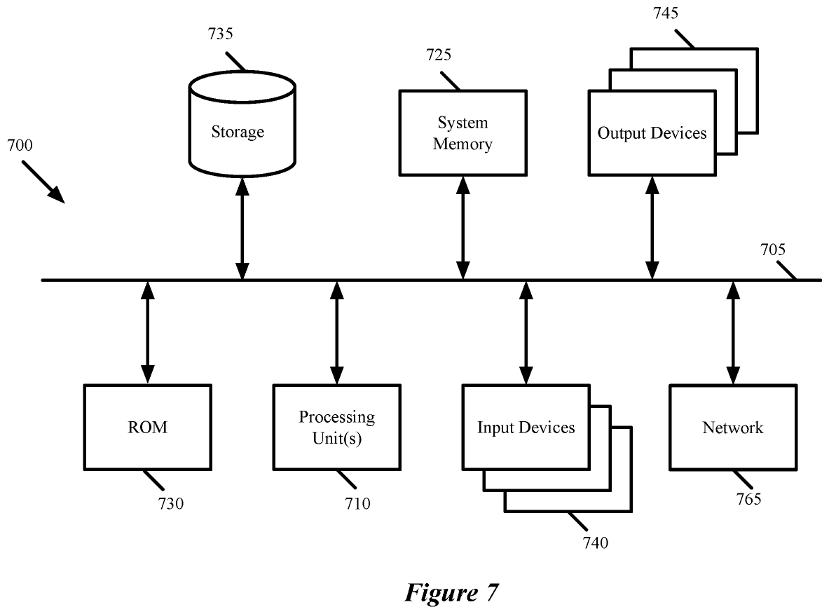

FIG. 7 conceptually illustrates an electronic system 700 with which some embodiments of the invention are implemented. The electronic system 700 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments.

The read-only-memory (ROM) 730 stores static data and instructions that are needed by the processing unit(s) 710 and other modules of the electronic system. The permanent storage device 735, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory is a volatile read-and-write memory, such a random-access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the electronic system. The input devices 740 include alphanumeric keyboards and pointing devices (also called “cursor control devices”). The output devices 745 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples electronic system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIGS. 3 and 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method for identifying policy misconfiguration in a datacenter, the method comprising:
based on flow data received for a plurality of data compute nodes (DCNs) in the datacenter, determining that an anomalous amount of data traffic relating to a particular DCN has been dropped;
using (i) the received flow data for the particular DCN and (ii) a set of recent policy configuration changes to determine policy configuration changes that contributed to the anomalous amount of dropped data traffic relating to the particular DCN; and
generating an alert for presentation to a user indicating the anomalous amount of data traffic and the contributing policy configuration changes.

2. The method of claim 1, wherein determining that an anomalous amount of data traffic relating to a particular DCN has been dropped comprises comparing an amount of dropped data traffic relating to the particular DCN over a particular time period to a historical baseline amount of dropped data traffic relating to the particular DCN.

3. The method of claim 1, wherein determining that an anomalous amount of data traffic relating to the particular DCN has been dropped comprises:
computing an average amount of dropped data traffic relating to the particular DCN each day over an extended time period; and
determining that the amount of dropped data traffic relating to the particular DCN for a current day is greater than a particular number of standard deviations above the average amount.

4. The method of claim 1, wherein determining that an anomalous amount of data traffic relating to the particular DCN has been dropped comprises:
computing an average ratio of allowed data traffic to total data traffic relating to the particular DCN each day over an extended time period; and
determining that a ratio of allowed data traffic to total data traffic relating to the particular DCN for a current day is less than the average ratio.

5. The method of claim 1, wherein determining that an anomalous amount of data traffic relating to the particular DCN has been dropped comprises:
analyzing dropped data traffic relating to the particular DCN over an extended time period to identify a set of port numbers to which the dropped data traffic was directed; and
determining that dropped data traffic relating to the particular DCN is directed to at least one port number not in the set of port numbers.

6. The method of claim 1, wherein determining that an anomalous amount of data traffic relating to the particular DCN has been dropped comprises:
assigning a first score based on a current amount of dropped data traffic relating to the particular DCN compared to a historical average amount of dropped data traffic relating to the particular DCN;
assigning a second score based on a ratio of allowed data traffic to total data traffic relating to the particular DCN compared to a historical average ratio of allowed data traffic to total data traffic relating to the particular DCN;
assigning a third score based on whether dropped data traffic relating to the particular DCN is directed to new port numbers compared to a historical analysis of dropped data traffic relating to the particular DCN; and
computing a total score that is a weighted average of the first, second, and third scores.

7. The method of claim 6 further comprising comparing the total score to a threshold score, wherein an anomaly is detected when the total score is greater than the threshold score.

8. The method of claim 7, wherein the threshold score is user-adjustable.

9. The method of claim 7 further comprising:
receiving user feedback regarding the detected anomaly; and
adjusting the weighting of the first, second, and third scores based on the user feedback.

10. The method of claim 1 further comprising:
receiving the flow data for the plurality of DCNs from a plurality of host computers on which the DCNs execute; and
receiving policy configuration changes for the datacenter from a set of network managers for the datacenter.

11. The method of claim 1, wherein the received flow data for the particular DCN comprises a plurality of flow attribute sets, each flow attribute set for a particular flow comprising at least a source network address, a destination network address, a destination port, a protocol, whether the particular flow was dropped, a set of firewall rules applied to the flow, and a set of security groups used to define the set of firewall rules.

12. The method of claim 11, wherein using the received flow data and the set of recent policy configuration changes comprises:
identifying the firewall rules applied to the dropped data traffic relating to the particular DCN and the security groups used to define the firewall rules applied to the dropped data traffic; and
querying the set of recent policy configuration changes to identify changes to the identified firewall rules and security groups.

13. The method of claim 1 further comprising generating a user interface display that comprises (i) a graph of dropped data traffic relating to the particular DCN over a historical time period and (ii) indications of the contributing policy configuration changes.

14. A non-transitory machine-readable medium storing a program which when executed by at least one processing unit identifies policy misconfiguration in a datacenter, the program comprising sets of instructions for:
based on flow data received for a plurality of data compute nodes (DCNs) in the datacenter, determining that an anomalous amount of data traffic relating to a particular DCN has been dropped;
using (i) the received flow data for the particular DCN and (ii) a set of recent policy configuration changes to determine policy configuration changes that contributed to the anomalous amount of dropped data traffic relating to the particular DCN; and
generating an alert for presentation to a user indicating the anomalous amount of data traffic and the contributing policy configuration changes.

15. The non-transitory machine-readable medium of claim 14, wherein the set of instructions for determining that an anomalous amount of data traffic relating to the particular DCN has been dropped comprises sets of instructions for:
computing an average amount of dropped data traffic relating to the particular DCN each day over an extended time period; and
determining that the amount of dropped data traffic relating to the particular DCN for a current day is greater than a particular number of standard deviations above the average amount.

16. The non-transitory machine-readable medium of claim 14, wherein the set of instructions for determining that an anomalous amount of data traffic relating to the particular DCN has been dropped comprises sets of instructions for:
computing an average ratio of allowed data traffic to total data traffic relating to the particular DCN each day over an extended time period; and
determining that a ratio of allowed data traffic to total data traffic relating to the particular DCN for a current day is less than the average ratio.

17. The non-transitory machine-readable medium of claim 14, wherein the set of instructions for determining that an anomalous amount of data traffic relating to the particular DCN has been dropped comprises sets of instructions for:
analyzing dropped data traffic relating to the particular DCN over an extended time period to identify a set of port numbers to which the dropped data traffic was directed; and
determining that dropped data traffic relating to the particular DCN is directed to at least one port number not in the set of port numbers.

18. The non-transitory machine-readable medium of claim 14, wherein the set of instructions for determining that an anomalous amount of data traffic relating to the particular DCN has been dropped comprises sets of instructions for:
assigning a first score based on a current amount of dropped data traffic relating to the particular DCN compared to a historical average amount of dropped data traffic relating to the particular DCN;
assigning a second score based on a ratio of allowed data traffic to total data traffic relating to the particular DCN compared to a historical average ratio of allowed data traffic to total data traffic relating to the particular DCN;
assigning a third score based on whether dropped data traffic relating to the particular DCN is directed to new port numbers compared to a historical analysis of dropped data traffic relating to the particular DCN; and
computing a total score that is a weighted average of the first, second, and third scores.

19. The non-transitory machine-readable medium of claim 18, wherein the program further comprises a set of instructions for comparing the total score to a threshold score, wherein an anomaly is detected when the total score is greater than the threshold score.

20. The non-transitory machine-readable medium of claim 14, wherein the program further comprises sets of instructions for:
receiving the flow data for the plurality of DCNs from a plurality of host computers on which the DCNs execute; and
receiving policy configuration changes for the datacenter from a set of network managers for the datacenter.

21. The non-transitory machine-readable medium of claim 14, wherein:
the received flow data for the particular DCN comprises a plurality of flow attribute sets each flow attribute set for a particular flow comprising at least a source network address, a destination network address, a destination port, a protocol, whether the particular flow was dropped, a set of firewall rules applied to the flow, and a set of security groups used to define the set of firewall rules; and
the set of instructions for using the received flow data and the set of recent policy configuration changes comprises sets of instructions for:
identifying the firewall rules applied to the dropped data traffic relating to the particular DCN and the security groups used to define the firewall rules applied to the dropped data traffic; and
querying the set of recent policy configuration changes to identify changes to the identified firewall rules and security groups.

22. The non-transitory machine-readable medium of claim 14, wherein the program further comprises a set of instructions for generating a user interface display that comprises (i) a graph of dropped data traffic relating to the particular DCN over a historical time period and (ii) indications of the contributing policy configuration changes.

23. An electronic system comprising:
a set of processing units; and
a non-transitory machine-readable medium storing a program which when executed by at least one of the processing units identifies policy misconfiguration in a datacenter, the program comprising sets of instructions for:
based on flow data received for a plurality of data compute nodes (DCNs) in the datacenter, determining that an anomalous amount of data traffic relating to a particular DCN has been dropped;
using (i) the received flow data for the particular DCN and (ii) a set of recent policy configuration changes to determine policy configuration changes that contributed to the anomalous amount of dropped data traffic relating to the particular DCN; and
generating an alert for presentation to a user indicating the anomalous amount of data traffic and the contributing policy configuration changes.
